(19) United States
(12) Patent Application Publication
(10) Pub. No.: US 2007/0231579 A1
(43) Pub. Date: Oct. 4, 2007

(54) WELDABLE COATING COMPOSITIONS, SUBSTRATES AND RELATED METHODS

(75) Inventors: Dennis W. Jones, Glenshaw, PA (US); Steven D. Perrine, Allison Park, PA (US); Richard M. Nugent, Allison Park, PA (US)

Correspondence Address: Robert A. Diaz;PPG Industries, Inc., Law - Intellectual Property 39S, One PPG Place, Pittsburgh, PA, 15272, US

(73) Assignee: PPG INDUSTRIES OHIO, INC., Cleveland, OH (US)

(21) Appl. No.: 11/688,560

(22) Filed: Mar. 20, 2007

Related U.S. Application Data
(60) Provisional application No. 60/786,963, filed on Mar. 29, 2006.

(51) Int. Cl. B32B 27/38; C08L 63/00

(52) U.S. Cl. 428/413; 523/451; 523/458; 523/468; 525/523; 428/416

(57) ABSTRACT

Provided is a coating composition containing (a) a resinous binder composition including an epoxy-functional polymer; and (b) a solid particulate composition dispersed in the resinous binder composition including (i) an electrically conductive material and (ii) a corrosion inhibitive material. The electrically conductive material (i) and the corrosion inhibitive material (ii) are present in a weight ratio of the conductive material (i) to the corrosion inhibitive material (ii) ranging from 1:8 to 12:1. The composition is characterized in that when applied to a conductive substrate to form a coating thereon, the coating is weldable. Coated substrates and related methods are further provided.

### FIELD OF THE INVENTION

This invention relates generally to weldable coating compositions for conductive substrates.

### BACKGROUND OF THE INVENTION

Weldable coatings containing an electrically conductive material can be used to provide an electrically conductive layer on various conductive substrates. Such weldable coatings can be applied at various stages in the manufacture of various industrial articles ranging from architectural construction materials to automotive substrates. For example, such weldable coatings can be applied to continuous steel sheets at the steel mill, then shipped to the end user where the steel sheet is formed into various parts, assembled together by welding processes, and optionally coated with any of a variety of subsequent coating layers. Alternatively, the steel sheet may be shipped to a custom coater for application of the weldable coating as well as other subsequently applied coating layers if desired. Depending upon the ultimate end-use, the weldable coatings may also contain additional materials to enhance corrosion-resistance of the coated substrate. In addition to enhanced corrosion resistance properties, it would be advantageous to provide a weldable coating which is sufficiently flexible to facilitate post-coating forming processes.

### SUMMARY OF THE INVENTION

The present invention relates to a coating composition comprising (a) a resinous binder composition comprising an epoxy-functional polymer; and (b) a solid particulate composition dispersed in the resinous binder composition comprising (i) an electrically conductive material and (ii) a corrosion inhibitive material. The electrically conductive material (i) and the corrosion inhibitive material (ii) are present in a weight ratio of the conductive material (i) to the corrosion inhibitive material (ii) ranging from 1:8 to 12:1. The composition is characterized in that when applied to a conductive substrate to form a coating thereon, the coating is weldable.

Coated substrates and related methods are further provided.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As previously mentioned, the present invention is directed to a coating composition comprising (a) a resinous binder composition that comprises an epoxy-functional polymer, and (b) a solid particulate composition dispersed in the resinous binder. The solid particulate composition comprises (i) and electrically conductive material and (ii) a corrosion inhibitive material in a weight ratio of the conductive material (i) to the corrosion inhibitive material (ii) ranging from 1:8 to 12:1. The composition in characterized in that when it is applied to a conductive substrate to form a coating thereon, the coating is weldable.

Unless otherwise indicated, as used herein, by “polymer” is meant adducts (that is, addition reaction products), oligomers and polymers, including both homopolymers and copolymers.

The “conductive substrate” can include conductive metallic substrates as well as non-metallic substrates which have been modified to be conductive, such as by the inclusion of some conductive material either by application of a conductive coating to the substrate or otherwise. In the case where the conductive substrate comprises a metallic substrate, the metallic substrate can include ferrous metals, non-ferrous metals and combinations thereof. Non-limiting examples of useful ferrous metals include iron, steel and alloys thereof. Non-limiting examples of useful steel materials include cold-rolled steel, galvanized (i.e., zinc coated) steel, electrogalvanized steel, stainless steel, pickled steel, zinc-iron alloy such as GALVANNEAL, and combinations thereof. Non-limiting examples of suitable non-ferrous metallic substrates can include aluminum, zinc, magnesium, and alloys thereof, such as GALVALUME and GALFAN zinc-aluminum alloys. Combinations or composites of ferrous and non-ferrous metals may be suitable, as well as combinations or composites of metallic conductive substrates with non-metallic conductive substrates.

As used herein, the term “weldable” with respect to a coating means that when cured on a conductive substrate, the coating formed from the composition of the present invention is sufficiently electroconductive to sustain a spot welding and joining operation as used in the assembly of various articles, for example, in the assembly of a vehicle in an automotive assembly plant.

The resinous binder may comprise any of a variety of epoxy-functional polymers known in the art. Suitable epoxy-functional polymers can include, for example, epoxy-functional polyester polymers, epoxy-functional acrylic polymers, epoxy-functional polyurethane polymers, epoxy-functional polyether polymers, mixtures thereof and copolymers thereof, all of which are well known in the art. The epoxy-functional polymers can have two or more epoxide or oxirane groups per molecule. The epoxy-functional polymers can be saturated or unsaturated, cyclic or acyclic, aliphatic, alicyclic, aromatic or heterocyclic. Also, if desired, the epoxy-functional polymers can have pendant or terminal hydroxyl groups and/or substituents such as halogen-, hydroxyl-, and ether-containing groups. It should be noted that mono-epoxide materials such as any of those known in the art may also be used either alone or in combination with polyepoxides.

Non-limiting specific examples of suitable epoxy-functional polymers can include polyepoxides comprised of epoxy polyethers which may be obtained, for example, by reacting an epihalohydrin (such as epichlorohydrin or epibromohydrin) with a di- or polyhydric alcohol in the presence of an alkali. Suitable polyhydric alcohols can include polyphenols such as resorcinol; catechol; hydroquinone, bis(4-hydroxyphenyl)2,2-propane (i.e., bisphenol A); bis(4-hydroxyphenyl)-1,1-isobutane; 4,4-dihydroxybenzophenone; bis(4-hydroxyphenol)-1,1-ethane; bis(2-hydroxyphenyl)-methane and 1,5-hydroxynaphthalene.

Further, non-limiting examples of suitable epoxy-functional polymers can include diglycidyl ethers of bisphenol A, such those available under the EPON® tradename from Shell Chemical Company, for example EPON® 828 and EPON® 1001. Other useful epoxy-functional polymers can include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, epoxy novolac resins, and polyepoxides that are partially defunctionalized by carboxylic acids, alcohol, water, phenols, mercaptans or other active hydrogen-containing compounds to give hydroxyl-containing polymers. Mixtures of any of the foregoing epoxy-functional polymers may be used.

The coating composition of the present invention may comprise a thermoplastic composition or a thermosetting composition. As used herein, a “thermoplastic composition” is a composition that when applied to form a coating, the coating can soften when exposed to heat and returns to its original condition when cooled to room temperature. As used herein, a “thermosetting composition” is a composition which when applied to form a coating, the coating “sets” irreversibly, for example, upon the application of heat or at ambient temperatures.

In the case where the coating composition of the present invention comprises a thermosetting composition, the coating composition can further include a curing agent which is reactive with the epoxy-functional polymer. The curing agent can comprise any of a variety of curing agents which are reactive with the epoxy groups of the epoxy-functional polymer and/or any other reactive functional groups present on the epoxy-functional polymer, such as hydroxyl groups, as are described above. Non-limiting examples of suitable curing agents can include, for example, cyanaguanadines, benzoguanamines, triazines, melamines, urea-formaldehyde resins, and/or isocyanates, including blocked isocyanates. Appropriate mixtures of curing agents may be used.

The coating composition may further comprise a compound selected from an amine (including blocked amines), an imine, mixtures thereof and copolymers thereof. Non-limiting examples of suitable amines and imines can include aliphatic, cycloaliphatic, and aromatic polyfunctional amines such as ethylene diamine, diethylene triamine, triethylene tetraamine, tetraethylene pentamine, 1,4-diaminobutane; 1,3-diaminobutane, hexamethylene diamine, diaminocyclohexane, and polyoxyalkylene amines; metaphenylene diamine, 1,4-aminonaphthalene; polyamides such as those derived from fatty acids, dimerized fatty acids or polymeric fatty acids and aliphatic polyamines; and boron trifluoride complexs such as boron trifluoride monoethylamine complex, boron trifluoride diethylamine complex, boron trifluoride triethylamine complex, boron trifluoride benzylamine, and any of a variety of imidazoles known in the art, for example alkyl and/or aryl mono- or poly-substituted imidazoles, such as 2-styrylimidazole, 1-benzyl-2-methylimidazole, 2-methylimidazole, and/or 2-butylimidazole. Note that for purposes of the present invention, an “imidazole” is intended to react as an “imine.” Copolymers of such amines and imines can include adducts of any of the aforementioned epoxy-functional polymers with any of the previously amines and/or imines. For example, the adduct can comprise the reaction product of a diglycidyl ether of bisphenol A and a polyoxyalkylene polyamine, and/or the reaction product of a diglydicyl ether of bisphenol A and imidazole. Such adducts may be present in the coating compositions of the present invention in combination with or in lieu of any of the above-described epoxy-functional polymers. Non-limiting examples of suitable blocked amines can include isocyanate blocked amines such as dimethyl amine reacted with hexamethylene diisocyanate and/or dimethylamine reacted with dichlorophenyl isocyanate.

In a particular embodiment of the present invention, the coating composition comprises an imine selected from an imidazole (as described above) and/or a reaction product of an imidazole and an epoxy-functional polymer (such as any of the aforementioned epoxy-functional polymers),

If present, the compound selected from an amine, an imine, mixtures thereof and copolymers thereof typically is present in an amount sufficient to achieve cure of the coating composition within 5 to 60 seconds, e.g., within 15 to 50 seconds, at a peak substrate temperature of at least 120° C., such as at least 140° C., or at least 160° C.

As previously mentioned, the coating compositions of the present invention include a solid particulate composition dispersed in the resinous binder composition. The solid particulate composition comprises (i) an electrically conductive material and (ii) a corrosion inhibitive material. The electrically conductive material (i) can include, but is not limited to, zinc, aluminum, iron, graphite, carbon black, molybdenum sulfide, iron phosphide, silicon, tungsten, stainless steel, and mixtures thereof. Suitable zinc materials are commercially available from ZINCOLI GmbH under the tradename ZINCOLIS 6200R 520. Suitable iron phosphide materials are commercially available from Occidental Chemical Corporation under the tradename FERROPHOS.

The electrically conductive material (i) is present in the coating composition in an amount sufficient to ensure that when the coating composition is applied to a conductive substrate and cured to form a coating on the substrate, the cured coating is weldable. The electrically conductive material (i) can be present in the coating composition in an amount ranging from 1 to 75 weight percent, such as 20 to 70 weight percent, or 30 to 65 weight percent, based on weight of total solids present in the coating composition.

The corrosion inhibitive material (ii) can include, but is not limited to, silicon, zinc phosphate, aluminum phosphates, calcium ion-exchanged silica, colloidal silica, synthetic amorphous silica, and molybdates such as calcium molybdate, zinc molybdate, barium molybdate, strontium molybdate, and mixtures thereof. Suitable calcium ion-exchanged silica is commercially available from W.R. Grace & Co. as SHIELDEX® AC3. Suitable colloidal silica is available from Nissan Chemical Industries, Ltd. Under the tradename SNOWTEX. Suitable amorphous silica is available from W.R. Grace & Co. under the tradename SYLOID®. The corrosion inhibitive material (ii) can be present in the coating composition in an amount ranging from 1 to 75 weight percent, such as 20 to 70 weight percent, or 30 to 65 weight percent, based on weight of total solids present in the coating composition. In some applications, for example where thin films are desirable, the composition may contain only corrosion inhibitive materials as described immediately above, with no electrically conductive material such as those materials described previously (i.e., as conductive material (i)).

Further, the electrically conductive material (i) and the corrosion inhibitive material (ii) are present in the coating composition in a weight ratio of the conductive material (i) to the corrosion inhibitive material (ii) ranging from 1:8 to 12:1, such as 6:1 to 10:1, for example, 8:1.

Additionally, the coating composition of the present invention also may contain a rubber and/or rubber-like material. Examples of suitable rubber and/or rubber-like materials can include, but are not limited to any natural or synthetic diene rubbers such as natural rubber; balata; gutta-percha; cis-polybutadiene; trans-polybutadiene; synthetic polyisoprene; polyoctenamer; and mixtures thereof. Other rubber and/or rubber-like materials can include without limitation polybutadiene; ethylene-propylene; EPDM; styrene-butadiene rubber; styrene-propylene-diene rubber, and mixtures thereof. These rubbers can be synthesized via the co-polymerization of functionalized monomers using metallocene catalysts or other single-site catalysts. The coating composition may also comprise chloroprene rubber; acrylonitrile rubber; acrylonitrile-butadiene rubber; styrene-ethylene block copolymer; maleic anhydride or succinate modified metallocene catalyzed ethylene copolymer; polypropylene resin; ionomer resin; polyamide; polyester; urethane; polyurea; chlorinated polyethylene; polysulfide rubber; flurocarbon; copolymers thereof, and mixtures thereof. In an embodiment of the present invention, the composition can comprise organic adducts of rubber, e.g., the adduct of a carboxy terminated butadiene with diglycidyl ester of bis-phenol A. Also, suitable are “nanorubbers” such as the nano-sized rubber materials available from Sinopec.

The coating composition of the present invention also may contain diluents if desired. Such materials typically are included to adjust the viscosity of the coating composition. Useful diluents and/or solvents can include water and any of a variety of organic solvents known in the art. Mixtures of water and organic solvents may also be used. Suitable non-limiting examples of organic solvents can include alcohols, such as ethanol and isopropanol; and alkyl ethers of glycols, such as 1-methoxy-2-propanol, and monoalkyl ethers of ethylene glycol, diethylene glycol and propylene glycol. Other suitable organic solvents can include, but are not limited to, ketones, esters and ethers, polar aprotic solvents such as n-methylpyrrolidone, aromatic solvents such as xylene and toluene, and aromatic solvent blends derived from petroleum such as those available under the tradename SOLVESSO®.

The coating composition of the present invention can contain other optional ingredients as are well known in the art. Such optional ingredients can include, for example, inorganic lubricant materials such as molybdenum disulfide particles; extender pigments such as iron oxides and iron phosphides, flow control agents, thixotropic agents, anti-settling agents, dehydrating agents, and wetting agents.

In an embodiment of the present invention, the coating composition is substantially free of chromium. For purposes of the present invention, as used herein, by “substantially free of chromium” is meant that a composition (i.e., the coating composition of the present invention and/or any pretreatment composition as described below) contains less than 2 weight percent, such as less than 0.05 weight percent, or less than 0.001, or less than 0.0001 weight percent of chromium-containing materials (expressed as CrO₃).

Further, as previously mentioned, the present invention is directed to a coated substrate comprising any of the conductive substrates described above; and any of the previously described coating compositions applied to the substrate to form a weldable coating layer thereon. The coating composition of the present invention can be applied to any of the aforementioned substrates by any conventional application techniques known in the art, such as by spraying, immersion, or roll-coating in a batch or continuous process.

The coating film thickness of the weldable coating can vary depending upon the end use requirements of the coated substrate. For example, to achieve sufficient corrosion resistance for coil metal automotive substrates, the applied weldable coating typically can have a film thickness of at least 1 micrometer, such as 1 to 20 micrometers, or from 2 to 5 micrometers. For other substrates and other end use applications, thinner or thicker coatings can be used.

After application, the weldable coating can be dried and/or any curable components thereof are cured to form a dried and/or cured weldable coating upon the substrate. The weldable coating can be dried at a temperature ranging up to 300° C. peak substrate temperature. In general, the coated substrate will be stoved for a period of time sufficient to vaporize any volatile components of the composition and/or to cure or set the resinous binder composition. Curing can be achieved at a peak substrate temperature of 100° C. to 400° C., such as 120° C. to 300° C., at cure times ranging from 5 to 60 seconds. In an embodiment of the present invention, curing can be achieved within 5 to 60 seconds at a peak substrate temperature of at least 120° C.

Prior to application of the coating composition of the present invention, the substrate to be coated typically is cleaned and/or pretreated to enhance properties such as adhesion and/or corrosion resistance. If the substrate to be coated comprises a metallic substrate, such pretreatment may include, for example inorganic materials using the techniques known in the art as “conversion” treatment or coating. This may include, for example, phosphatizing processes, chromatizing processes or a conversion treatment using a pretreatment composition that is substantially free of chromium. Such chromium-free compositions can include complex fluorides of titanium and/or zirconium.

In one embodiment of the present invention, the coating composition can be applied directly to the substrate surface (with or without a prior cleaning step as described above) with no intervening pretreatment and/or coating layer (e.g., a conversion coating layer) therebetween.

Since the weldable coated substrate prepared according to the present invention is electroconductive, topcoating of the coated substrate by application of an electrodeposition primer coating composition is of particular interest. Any of the electrodepositable primer coating compositions well known in the art can be used for this purpose. Typically, the electrodeposition primer coating layer has a film thickness of less than 30 microns, such as less than 25 microns or less than 22 microns, or less than 20 microns.

Moreover, for some applications such as automotive applications, one or more topcoats can be applied to the electrodeposition primer coating layer. Such topcoats can include, for example, a primer-surfacer coating and/or one or more appearance-enhancing topcoatings (e.g., a basecoat/clearcoat system) over the primer-surfacer coating.

The following examples are intended to illustrate the invention, and should not be construed as limiting the invention in any way.

### EXAMPLES

### Example 1

The following example describes the preparation of an epoxy-rubber adduct used as a component in the composition of the present invention. The adduct was prepared as described below.

| | | | Weight |
|---|---|---|---|
| Charge | Ingredient | Supplier | (grams) |
| 1 | HYCAR CTBN¹ | Noveon | 1381.0 |
| 2 | EPON 828² | Hexion | 241.9 |
| 3 | Ethyl triphenyl phosphonium | Rohm and Haas | 3.1 |
| | iodide | | |
| 4 | Propylene glycol methyl ether | Dow Chemical Co. | 625.9 |
| | acetate | | |
| 5 | Propylene glycol methyl ether | Dow Chemical Co. | 249.3 |
| Total | | | 2501.2 |

¹Carboxyl terminated butadiene-acrylonitrile copolymer
²Diglycidyl ether of bisphenol A.

Charges 1 through 5 were added to a laboratory reactor fitted with a condenser, thermometer, and stirring device, and heated to a temperature of 120° C. The epoxy equivalent weight (EEW) was measured until the EEW was greater than 3907. The resulting resin had a solids content of 65.0%, an acid value of 0.0, and an EEW of 3907.

### Example 2

The following example describes the preparation of a blocked isocyanate used as a component in the composition of the present invention. The blocked isocyanate was prepared as described below.

| | | | Weight |
|---|---|---|---|
| Charge | Ingredient | Supplier | (grams) |
| 1 | Polyester polyol¹ | Noveon | 997.1 |
| 2 | Isophorone diIsocyanate | Hexion | 241.9 |
| 3 | Dimethyl amine phosphonium iodide | Air Products | 76.5 |
| 4 | Propylene glycol methyl ether acetate | Dow Chemical | 493.2 |
| Total | | | 2012.8 |

¹Polyester polyol made by reacting 4.53 moles of diethylene glycol and 3.59 moles of adipic acid.

The polyester polyol was charged to a 5 L flask and heated to a temperature of 50 to 60° C. at which time Charge 2 was added over a period of 1 hour, as the temperature was maintained at less than 90° C. Once the addition was completed, the solution was heated to a temperature of 90° C. and held until an isocyanate (NCO) equivalent weight of between 700 to 800 was achieved. The mixture then was cooled to a temperature of less than 50° C.

### Example 3

This example describes the preparation of an epoxy-imidazole adduct which is used as a component in the composition of the present invention. The epoxy-imidazole adduct was prepared as described below.

| Charge | Ingredient | Supplier | Weight (grams) |
|---|---|---|---|
| 1 | 2-methyl imidazole | Air Products | 164.0 |
| 2 | Propylene glycol methyl ether | Dow Chemical | 164.0 |
| 3 | EPON 828 | Hexion | 376.0 |
| 4 | Propylene glycol methyl ether | Dow Chemical | 376.0 |
| Total | | | 1080.0 |

Charges 1 and 2 were added to a laboratory reactor fitted with a condenser, thermometer, and stirring device, and heated to a temperature of 100° C. Charges 3 and 4 were premixed and slowly added to the reaction mixture while maintaining a temperature of 100° C. The epoxy equivalent weight (EEW) was followed until the EEW reached a value greater than 30,000. The solution was cooled and discharged. The final epoxy-imidazole adduct had a solids content of 50%.

### Example 4

This example describes a composition according to the present invention. The composition was prepared as described below,

| | | Weight | |
|---|---|---|---|
| Ingredient | Supplier | (grams) | |
| Charge 1: | | | |
| EPON 828 | Hexion Specialty | | 13.35 |
| | Chemicals | | |
| DER 736¹ | Dow Chemical Co. | | 7.42 |
| Silicon powder | Elkem | | 6.52 |
| Epoxy-rubber adduct of Example 1 | | | 2.12 |
| Charge 2: | | | |
| Dicyandiamide | Degussa | | 2.82 |
| Zinc dust | US Zinc | | 50.27 |
| Charge 3: | | | |
| Propylene glycol methyl ether | Dow Chemical Co. | | 12.13 |
| Blocked isocyanate of Example 2 | | | 3.53 |
| Epoxy-imidazole adduct of | | | 1.84 |
| Example 3 | | | |
| | | Total: | 100.0 |

¹Diglycidyl Ether of Poly(propylene glycol).

The Charge 1 ingredients were added to a sand mill and milled as a paste until a Hegman grind of 6 was achieved. The paste from Charge 1 was transferred to a high speed mixer and Charge 2 was added. This mixture was mixed under high agitation until a Hegman grind of 6 was achieved. Charge 3 was then added and mixed.

### Test Procedures

The composition Example 4 was applied to cleaned electro-galvanized steel substrate which was treated with a commercial chemical pretreatment, commercially available as BONDERITE 1456. The coating was applied using a wire-wound rod applicator and cured for approximately 30 seconds until a peak metal temperature of 450° F. was achieved. The resulting dry film thickness of the coating was 4.0 microns.

As a Comparative Example, a commercially-available conductive primer, available as BONAZINC BZ3001 from PPG Industries, Inc. was applied over electrogalvanized steel substrate which had been cleaned and treated with a chrome-free pretreatment, NUPAL 456BZR commercially available from PPG Industries, Inc. The primer was applied with a wire-wound rod and cured for 30 seconds to a peak metal temperature of 450° F. The resulting coating thickness was approximately 3.5 microns.

The following Table 1 provides test data comparing the composition of Example 4 (i.e., the composition in accordance with the present invention) with the commercial weldable primer, BONAZINC BZ3001.

DATA TABLE 1

| | | BONAZINC BZ3001 |
|---|---|---|
| Measured Property | Example 4 | (comparative example) |
| Film thickness (microns) | 4.0 | 3.5 |
| Solvent resistance¹ | 100+ | 25 |
| Reverse impact² | No adhesion loss | No adhesion loss |
| Flexibility³ | 0 T No Adhesion Loss | 3T |
| Corrosion resistance⁴ | No red rust | Moderate red rust |
| Corrosion testing⁵ | No red rust | Moderate red rust |

¹Methyl ethyl ketone double rubs.
²ASTM D2794-93 Standard Test Method for Resistance of Organic Coatings to the Effects of Rapid Deformation (Impact).
³ASTM D4145-83 Standard Test Method for Coating Flexibility of Pre-painted Sheet (The T-bend rating is the minimum number of thicknesses of metal around which the coated sheet is bent without adhesion loss.).
⁴ASTM B117-97 Standard Practice for Operating Salt Spray (Fog) Apparatus.
⁵Corrosion testing using VDA 621-415 (10 cycles). [VDA 621-415 - Testing of Corrosion Protection of Vehicle Paint by Alternating Cycles Test].

The data presented in Table 1 above, illustrate that composition of the present invention as described in Example 4 demonstrates solvent resistance, corrosion resistance, and flexibility equal to or better than the commercial weldable primer, BONAZINC BZ3001 of the comparative example.

### Example 5

This example describes the preparation of composition in accordance with the present invention. The composition was prepared as described below.

| | | Weight | |
|---|---|---|---|
| Ingredient | Supplier | (grams) | |
| Charge 1: | | | |
| EPON 828 | Hexion Specialty | | 9.85 |
| | Chemicals | | |
| DER 736 | Dow Chemical Co. | | 5.47 |
| Silicon powder | Elkem | | 5.71 |
| Epoxy-rubber adduct of Example 1 | | | 1.65 |
| Zinc dust | US Zinc | | 44.08 |
| Charge 2: | | | |
| Propylene glycol methyl ether | Dow Chemical Co. | | 14.06 |
| N′-(3,4-dichlorophenyl)-N,N- | Degussa | | 1.07 |
| dimethyl-urea | | | |
| Epoxy-imidazole adduct of | | | 18.10 |
| Example 3 | | | |
| | | Total: | 100.0 |

Charge 1 ingredients were added into a high speed disperser and mixed under high agitation until a Hegman value of 6 was achieved. Charge 2 was then added and mixed. The resulting composition was applied to cleaned, hot-dipped galvanized steel substrate treated with a commercial chemical pretreatment, BONDERITE 1456. The coating composition was applied with a wire-wound rod applicator and cured for approximately 30 seconds until a peak metal temperature of 320° F. (160° C.) was achieved. The coating dry film thickness was 4.0 microns. As a comparative example, conductive primer, BONAZINC BZ3000R, commercially available from PPG Industries, Inc. was applied over the same hot-dipped galvanized steel substrate which had been cleaned and treated with a chrome-containing pretreatment, BONDERITE 1415A (available from Henkel). The primer was applied with a wire-wound rod and cured for 30 seconds to a peak metal temperature of 490° F. The coating dry film thickness was 3.5 microns.

Test data showing comparative test results for the composition of Example 5 prepared in accordance with the present invention versus the commercial conductive primer, BONAZINC BZ3000R of the comparative example are presented in the following Table 2.

DATA TABLE 2

| | | BONAZINC BZ3000R |
|---|---|---|
| Measured Property | Example 5 | (comparative example) |
| Film thickness (microns) | 4.0 | 3.5 |
| Solvent resistance | 100+ | 25 |
| Reverse impact | No adhesion loss | No adhesion loss |
| Flexibility | 0 T | 3T |
| Corrosion testing¹ | No red rust | Moderate red rust |

¹Testing conducted in accordance with GM TM 54-26 test method for scab corrosion.

The data presented in Table 2 above illustrate that compositions prepared in accordance with the present invention demonstrates solvent resistance, corrosion resistance, and flexibility equivalent to or better than the commercial conductive primer of the comparative example.

Whereas particular embodiments of this invention have been described above for purposes of illustration, it will be evident to those skilled in the art that numerous variations of the details of the present invention may be made without departing from the invention as defined in the claims.

Therefore, we claim:

1. A coating composition comprising
(a) a resinous binder composition comprising an epoxy-functional polymer; and
(b) a solid particulate composition dispersed in the resinous binder composition comprising
(i) an electrically conductive material
(ii) a corrosion inhibitive material
in a weight ratio of the conductive material (i) to the corrosion inhibitive material (ii) ranging from 1:8 to 12:1,
wherein the composition is characterized in that when applied to a conductive substrate to form a coating thereon, the coating is weldable.

2. The composition of claim 1, wherein the resinous binder (a) further comprises a curing agent which is reactive with the epoxy-functional polymer.

3. The composition of claim 2, wherein the curing agent comprises cyanoguanadine, benzoguanamine, triazine, and/or melamine.

4. The composition of claim 1, wherein the corrosion inhibitive material comprises silicon, zinc phosphate, aluminum phosphate, calcium molybdate, zinc molybdate, barium molybdate, and/or strontium molybdate.

5. The composition of claim 1, wherein the electrically conductive material comprises zinc, aluminum, graphite, silicon, carbon black, molybdenum sulfide, and/or iron phosphide.

6. The composition of claim 1, further comprising a compound selected from an amine, an imine, mixtures thereof and/or co-polymers thereof.

7. The composition of claim 6, wherein the composition comprises an imine selected from an imidazole and/or a reaction product of an imidazole and an epoxy-functional polymer.

8. The composition of claim 6, wherein the compound is present in an amount sufficient to achieve cure of the composition within 5 to 60 seconds at a peak substrate temperature of at least 120° C.

9. The composition of claim 1, further comprising a rubber and/or rubber-like material.

10. The composition of claim 8, wherein the substrate comprises a metallic substrate.

11. The composition of claim 1, wherein the weight ratio of the conductive material (i) to the corrosion inhibitive material (ii) is 8:1.

12. A coated substrate comprising
(a) a conductive substrate; and
(b) the coating composition of claim 1 applied to the substrate to form a weldable coating layer thereon.

13. The coated substrate of claim 12, wherein the conductive substrate comprises a metallic substrate.

14. The coated substrate of claim 12, further comprising (c) an electrodeposition primer composition applied to the weldable coating layer of (b) to form an electrodeposition primer layer thereon.

15. The coated substrate of claim 14, wherein the electrodeposition primer layer has a film thickness of less than 25 microns.

16. The coated substrate of claim 14, wherein the electrodeposition primer layer has a film thickness of 20 microns or less.

17. The coated substrate of claim 14, further comprising (d) a primer-surfacer coating composition applied to the electrodeposition primer layer to form a primer-surfacer layer thereon.

18. The coated substrate of claim 17, further comprising (e) a top coat composition applied to the primer-surfacer layer to form a top coat layer thereon.

19. The coated substrate of claim 12, wherein a pretreatment composition is applied to the conductive substrate prior to application of the coating composition of claim 1.

20. The coated substrate of claim 19, wherein the pretreatment composition is substantially free of chromium.

21. The coated substrate of claim 12, wherein the coating composition is applied directly to the substrate surface with no intervening pretreatment and/or coating layer therebetween.

22. A method of coating a conductive substrate comprising
(a) providing a conductive substrate; and
(b) applying the composition of claim 1 to the substrate.
